(19) United States
(12) Patent Application Publication
(10) Pub. No.: US 2006/0090610 A1
(43) Pub. Date: May 4, 2006

(54) Sleeve with rounded ridges and grooves

(76) Inventor: I-He Liao, Taichung (TW)

Correspondence Address: LIAO I-HE;3F-5, NO.22, LANE 146, DER-FR ROAD, SOUTH AREAS, TAICHUNG, 402, TW

(21) Appl. No.: 10/979,661

(22) Filed: Nov. 4, 2004

(51) Int. Cl. B25B 13/06

(52) U.S. Cl. 81/121.1

(57) ABSTRACT

A sleeve includes a passage defined therethrough so as to accommodate a polygonal object. A plurality of ridges extend from an inner periphery of the passage at even spaces and grooves are defined between the ridges. Each of the grooves is a rounded groove and each ridge has two side surfaces and a top surface which is in connection with the two side surfaces. A clamp angle between two extension lines of the two side surfaces of each ridge is in a range between 40 to 60 degrees.

### FIELD OF THE INVENTION

The present invention relates to a sleeve for accommodating polygonal objects and the inner periphery of the sleeve includes rounded ridges and grooves.

### BACKGROUND OF THE INVENTION

A conventional sleeve 1 for accommodating polygonal objects such as a nut 2 or a screw head is disclosed in FIG. 1, and generally includes six sides and six corners 10, each corner 10 is formed at the joint of two adjacent sides. As shown in FIG. 1A, when accommodating a nut 2 in the sleeve 1, the peaks of the nut 2 are supposed to be engaged with the corners 10 of the sleeve 1 and the sides 101 drive the sides of the nut 2 to rotate with the sleeve 1. However, it is noted that the thickness of the sleeve 1 at the corners is thinner than the rest portion of the sleeve 1 and the stress concentration could break the thin area. Because there is only six sides 101 so that the sleeve 1 cannot be used to tighten or loosen an object with eight or more than eight sides. Furthermore, when rotating the sleeve 1, the peaks of the nut 2 could be worn due to slippery between the sleeve 1 and the nut 2 as shown in FIG. 1B.

The present invention intends to provide a sleeve that includes rounded ridges and grooves so as to grasp the object at multiple points and the rounded ridges and grooves can bear larger stress.

### SUMMARY OF THE INVENTION

The present invention relates to a sleeve that includes a passage defined therethrough and a plurality of ridges extend from an inner periphery of the passage and grooves are defined between the ridges. Each of the grooves is a rounded groove and each ridge has two side surfaces and a top surface which is in connection with the two side surfaces. A clamp angle between two extension lines of the two side surfaces of each ridge is in a range between 40 to 60 degrees.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a nut is accommodated in the passage in a conventional sleeve;

FIG. 1A shows a peak of the nut is engaged with the corner of the conventional sleeve;

FIG. 1B shows the area where the corner of the conventional sleeve is located is broken due to stress concentration;

FIG. 2 is an end view to show the sleeve of the present invention;

FIG. 3 is an enlarged view to show the profile of the ridges and grooves of the sleeve of the present invention;

FIG. 4 shows a star-shaped object is accommodated in the passage of the sleeve of the present invention;

FIG. 5 shows an octahedral object is accommodated in the passage of the sleeve of the present invention, and

FIG. 6 shows a hexagonal object is accommodated in the passage of the sleeve of the present invention.

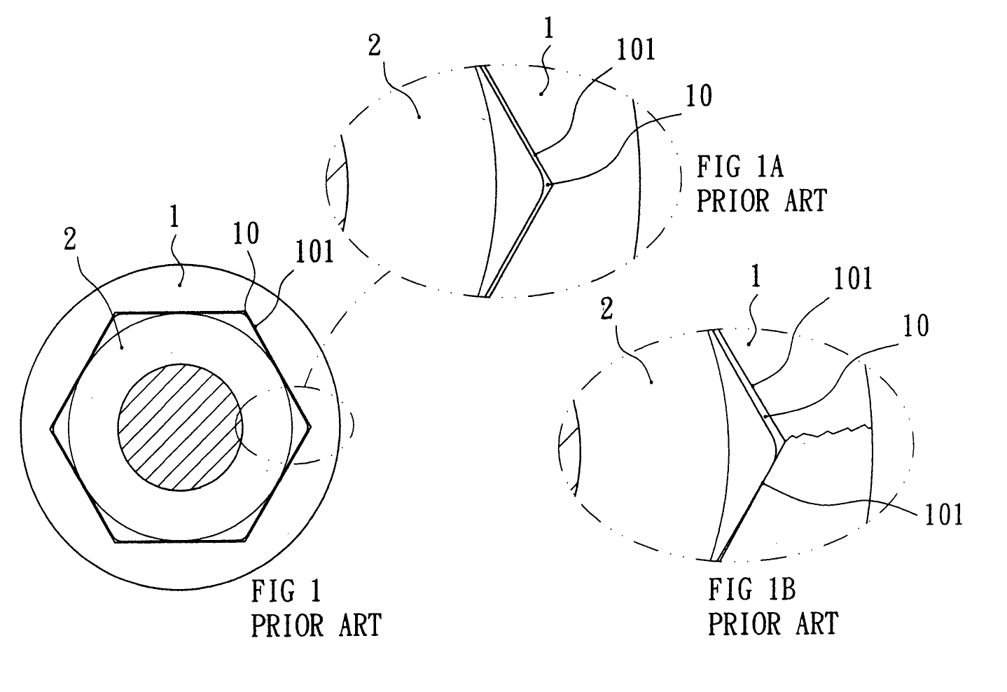

### DETAILED DESCRIPTION OF THE PREFERRED EMBODIMENT

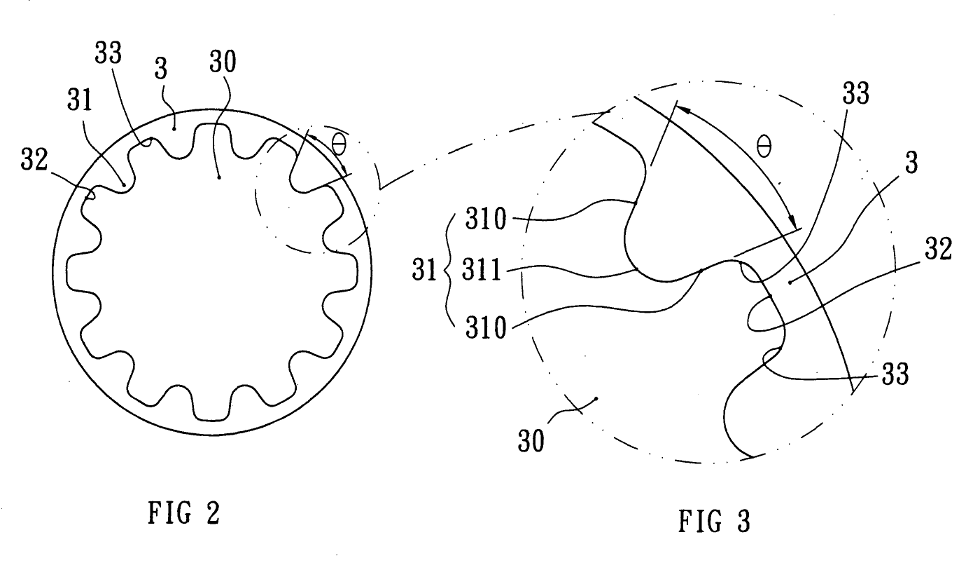

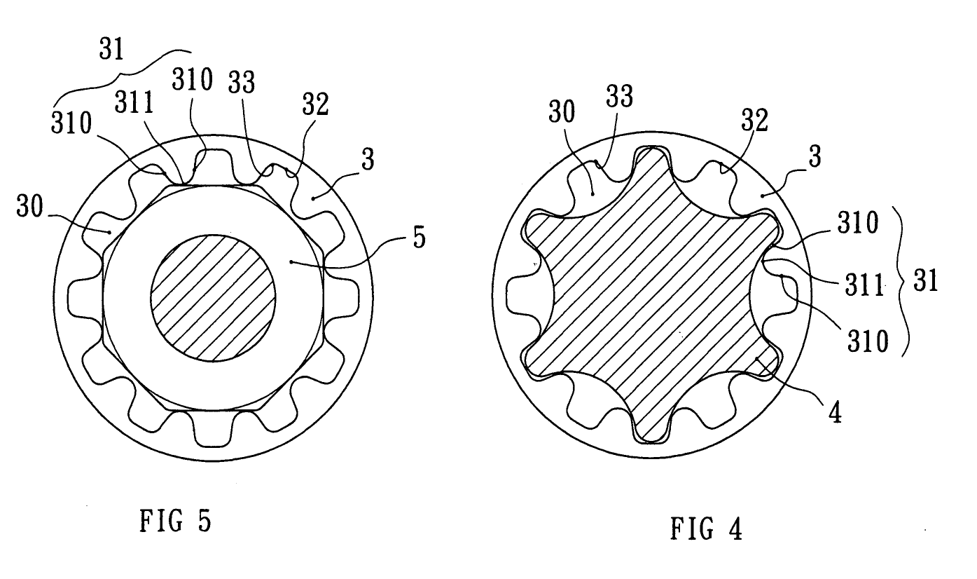

Referring to FIGS. 2 and 3, the sleeve 1 of the present invention comprises a passage 30 defined therethrough and a plurality of ridges 31 extend from an inner periphery thereof at even spaces and grooves 32 are defined between the ridges 31. Each of the grooves 32 is a rounded groove with a substantially flat inner bottom connected between two rounded inner corners 33, and each ridge 31 has two side surfaces 310 and a top surface 311 which is in connection with the two side surfaces 310. A clamp angle θ between two extension lines of the two side surfaces 310 of each ridge 31 is in a range between 40 to 60 degrees, preferably, the clamp angle θ is 45 degrees. The rounded grooves 32 with rounded inner corners 33 reduce the risks of stress concentration and the tapered side surfaces 310 allow the ridges 31 to be wide and strong enough.

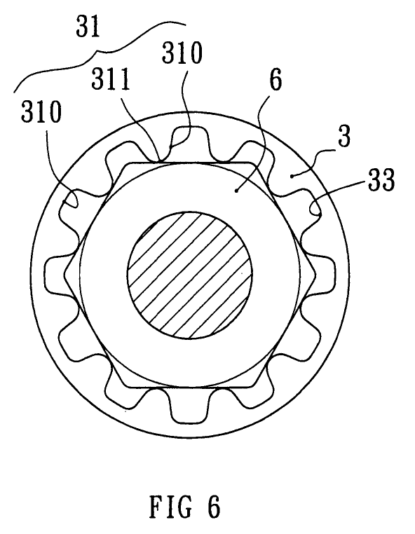

FIG. 4 shows a star-shaped object 4 is accommodated in the passage 30 of the sleeve 3 and all the six peaks of the object 4 are engaged with the grooves 32. FIG. 5 shows an octahedral object 5 is accommodated in the passage 30 of the sleeve 3 wherein the ridges 31 of the sleeve 3 contact one of the eight sides of the object 4. FIG. 6 shows a hexagonal object 6 is accommodated in the passage 30 of the sleeve 3.

The sleeve 3 of the present invention can accommodate different types of objects and the profile of the ridges 31 and grooves 32 effectively reduces affect due to stress concentration.

While we have shown and described the embodiment in accordance with the present invention, it should be clear to those skilled in the art that further embodiments may be made without departing from the scope of the present invention.

What is claimed is:

1. A sleeve comprising:
a passage defined therethrough and a plurality of ridges extending from an inner periphery thereof at even spaces and grooves defined between the ridges, each of the grooves being a rounded groove and each rounded groove has a substantially flat inner bottom connected between two rounded inner corners, each ridge having two side surfaces and a top surface which is in connection with the two side surfaces, a clamp angle between two extension lines of the two side surfaces of each ridge being in a range between 40 to 60 degrees.

2. The sleeve as claimed in claim 1, wherein the clamp angle is 45 degrees.
